(19) United States
(12) Patent Application Publication
(10) Pub. No.: US 2004/0156166 A1
(43) Pub. Date: Aug. 12, 2004

(54) Control panel of washing machine

(76) Inventors: Yang Hwan No, Changwon-si (KR); Han Ki Cho, Changwon-si (KR); Seong Jin Cho, Changwon-si (KR)

Correspondence Address: BIRCH STEWART KOLASCH & BIRCH, PO BOX 747, FALLS CHURCH, VA, 22040-0747, US

(21) Appl. No.: 10/721,321

(22) Filed: Nov. 26, 2003

(30) Foreign Application Priority Data
Nov. 29, 2002 (KR) P2002-0075353

(51) Int. Cl. H02B 1/00

(52) U.S. Cl. 361/600

(57) ABSTRACT

Disclosed is a control panel of a washing machine, in which buttons on a display panel are disposed independent from corresponding switches on a display substrate. The present invention includes a frame provided on a cabinet to form an exterior, a display panel on a front side of the frame to have at least one button formed thereon, a display substrate in rear of the display panel to have at least one switch formed thereon, and a switch lever having one end fixed to a backside of the display panel and the other end disposed over the switch, the switch lever operating the switch by receiving an external force applied to the button.

This application claims the benefit of Korean Application(s) No. 10-2002-0075353 filed on Nov. 29, 2002, which is/are hereby incorporated by reference.

### BACKGROUND OF THE INVENTION

1. Field of the Invention

The present invention relates to a washing machine, and more particularly, to a control panel of a washing machine, in which buttons on a display panel are disposed independent from corresponding switches on a display substrate.

2. Discussion of the Related Art

Generally, a washing machine performs washing, rinsing, and dewatering to eliminate dirt or filth attached to a laundry using interaction between water and detergent. And, such a washing machine belongs to one of a pulsator type, an agitator type, and a drum type.

A control panel is installed in the washing machine to control an operation of the washing machine.

FIG. 1 is a schematic cross-sectional view of a drum type washing machine according to a related art.

Referring to FIG. 1, in a drum type washing machine according to a related art, a cabinet 2 made of a metal-based material forms an exterior. An entrance is formed at a front side of the cabinet 2, and a door 20 is installed at the entrance to prevent a laundry from popping out. And, a tub 6 supported by a spring 4 is installed in the cabinet 2 to hold water.

A drum 8 in which the laundry and detergent are put is rotatably installed in the tub 6. A rotational shaft 14 coupled with a motor 12 is installed in a rear side of the drum 8 to transfer a driving force to the drum 8. And, lifts 10 are installed on an inside of the drum 8 to pull up the laundry to fall.

Meanwhile, a gasket 22 formed of such an elastic material as rubber is installed between the door 20 and the tub 6. The gasket 22 alleviates a shock generated from a rotation of the drum 8 as well as makes the door 20 airtight to prevent the water from leaking.

A damper 16 is installed at one side under the tub 6. The damper 16 attenuates the vibration transferred to the tub 6 through the rotational shaft 14 while the washing machine operates.

Moreover, a water supply hose 28, a water supply valve, and a detergent box 32 are installed in an upper part of the cabinet 2 to supply the water and detergent to the tub 6. And, a drain pump 24 and a drain hose 26 are installed at one side under the tub 6 to circulate or discharge the water.

Meanwhile, a control panel 34, on which electronic parts for controlling an operation of the drum type washing machine are provided, is installed on a top of the cabinet 2. The control panel 34 is used for displaying an operational status of the drum type washing machine or controlling the operation of the washing machine by a user himself.

FIG. 2 is a perspective view of a control panel of a washing machine according to a related art, and FIG. 3 is a cross-sectional view of a control panel according to a related art.

Referring to FIG. 2 and FIG. 3, a control panel 34 according to a related art consists of a frame 35 on a cabinet 2, a display panel 38 on a front side of the frame 35, and a display substrate 42 in rear of the display panel 38.

A multitude of buttons 36 are provided on the display panel 38, and display parts (not shown in the drawing) for displaying an operational status of the washing machine and switches for controlling an operation of the washing machine are formed on the display substrate 42.

A button protrusion 44 protruding toward the display substrate 42 is formed beneath each of the buttons 36, and each of the switches 40 is provided under the corresponding button protrusion 44.

Hence, if the button 36 is pressed to go down, the corresponding switch 40 is brought contact with the button protrusion 44 to be turned on/off. A non-explained numeral ‘48’ indicates a display window for displaying the operational status of the washing machine.

Meanwhile, various kinds of display windows and buttons are provided on the display panel as the size of the washing machine increases, whereby an arrangement area of the buttons increases as well.

However, since the switch is formed in rear of the corresponding button in the related art control panel, the display substrate is prepared to have a size similar to the button arrangement area.

Hence, as the size of the display substrate has to increase, so does the cost for preparing the display substrate.

Moreover, the buttons are formed thick in density on a predetermined area in case of downsizing the display substrate, whereby the locations of the buttons are limited.

### SUMMARY OF THE INVENTION

Accordingly, the present invention is directed to a control panel of a washing machine that substantially obviates one or more of the problems due to limitations and disadvantages of the related art.

An object of the present invention, which has been devised to solve the foregoing problem, lies in providing a control panel of a washing machine, in which buttons on a display panel are disposed independent from corresponding switches on a display substrate, respectively.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a control panel of a washing machine according to the present invention includes a frame provided on a cabinet to form an exterior, a display panel on a front side of the frame to have at least one button formed thereon, a display substrate in rear of the display panel to have at least one switch formed thereon; and a switch lever having one end fixed to a backside of the display panel and the other end disposed over the switch, the switch lever operating the switch by receiving an external force applied to the button.

In this case, a lever loading part is formed on the backside of the display panel and the switch lever is coupled with the lever loading part.

And, a coupling recess is formed at the lever loading part and a protrusion to be inserted in the coupling recess is formed at the switch lever.

Meanwhile, an elastic part is provided at the switch lever to return the switch lever to an original state when the external force applied to the button is released. And, the elastic part circularly becomes curved to elastically expand or contract according to the external force.

Moreover, a button protrusion is formed at a bottom of the button to be brought contact with the switch lever once the external force is applied to the button. Instead, a protrusion may be formed at a top of the switch lever to be brought contact with the first lever once the external force is applied to the button.

Meanwhile, a bent part is formed at one side of the switch lever. And, a rib is provided at the bent part for rigidity reinforcement.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic cross-sectional view of a drum type washing machine according to a related art;

FIG. 2 is a perspective view of a control panel of a washing machine according to a related art;

FIG. 3 is a cross-sectional view of a control panel according to a related art;

FIG. 4 is a perspective view of a control panel of a washing machine according to the present invention;

FIG. 5 and FIG. 6 are cross-sectional views of a control panel according to the present invention;

FIG. 7 and FIG. 8 are perspective views of a lever according to the present invention; and

FIG. 9 and FIG. 10 are cross-sectional views for explaining an operation of a control panel according to the present invention.

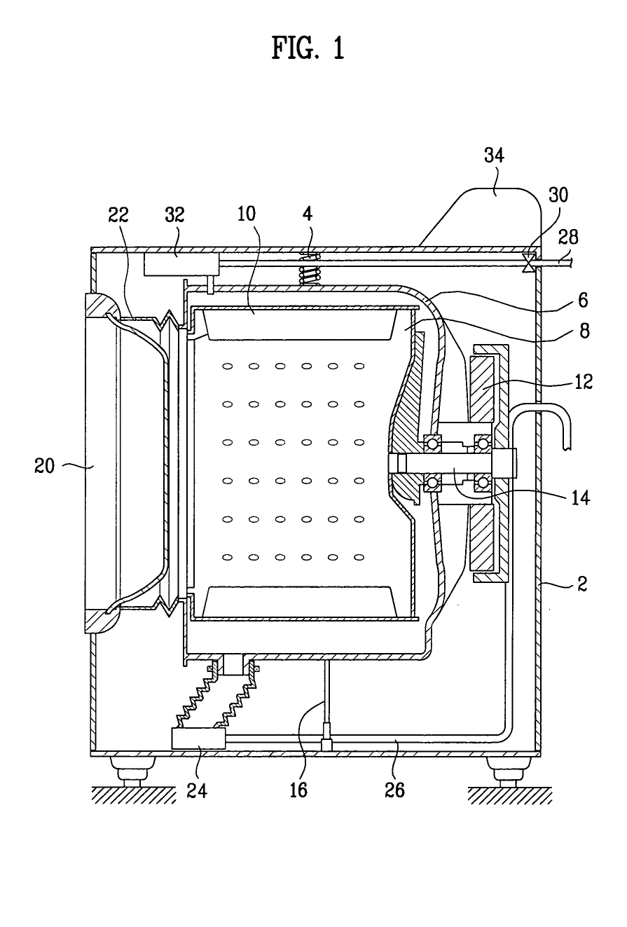

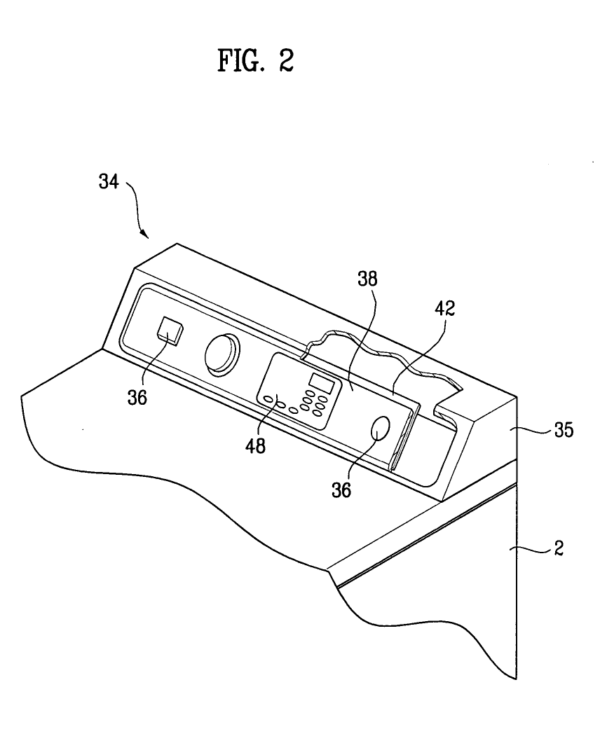

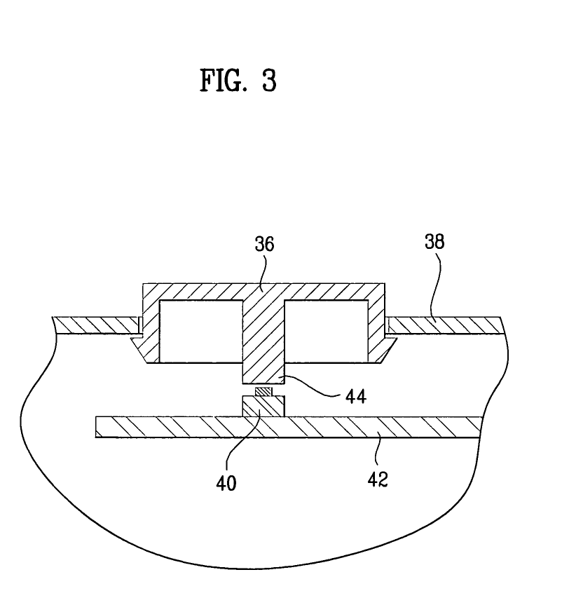

### DETAILED DESCRIPTION OF THE PREFERRED EMBODIMENT(S)

Reference will now be made in detail to the preferred embodiment(s) of the present invention, examples of which are illustrated in the accompanying drawings. Throughout the drawings, like elements are indicated using the same or similar reference designations where possible.

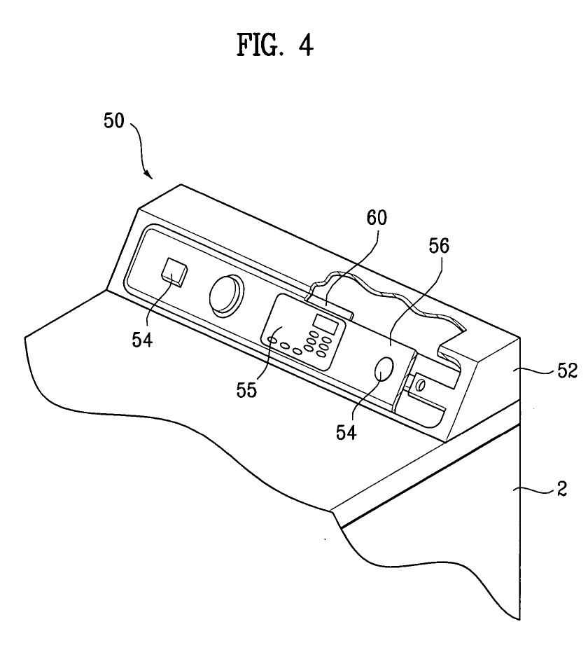

FIG. 4 is a perspective view of a control panel of a washing machine according to the present invention.

Referring to FIG. 4, a control panel 50 of a washing machine according to the present invention includes a frame 52 provided on a cabinet 2 to form an exterior, a display panel 56 installed on a front side of the frame 52, and a display substrate 60 provided in rear of the display panel 56.

A multitude of buttons 54 operated by a user and a display window 55 for displaying an operational status of the washing machine are formed on the display panel 56.

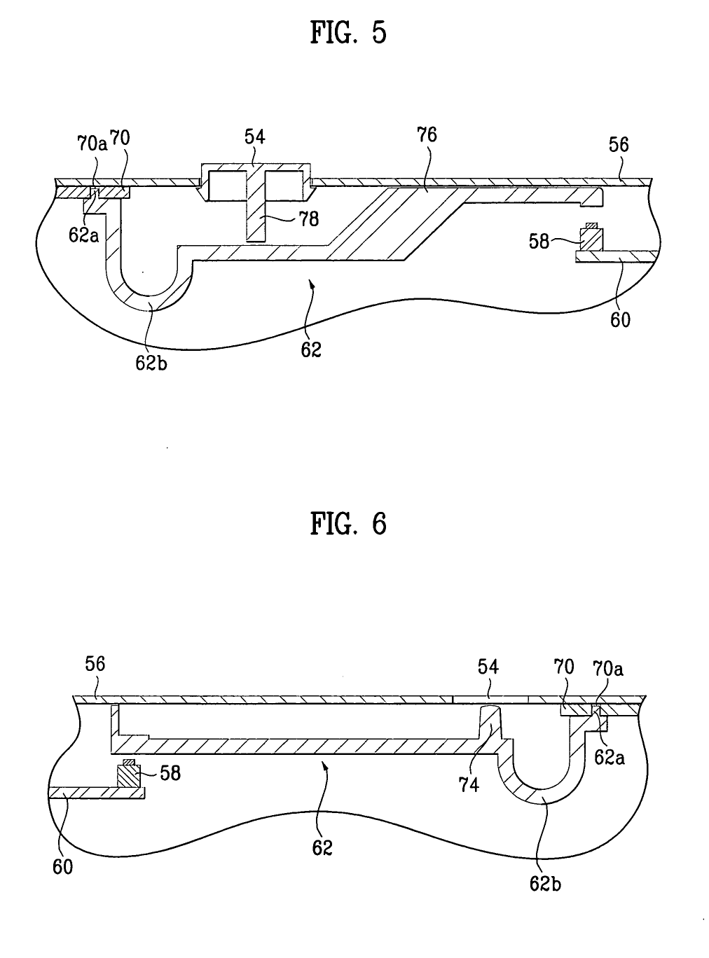

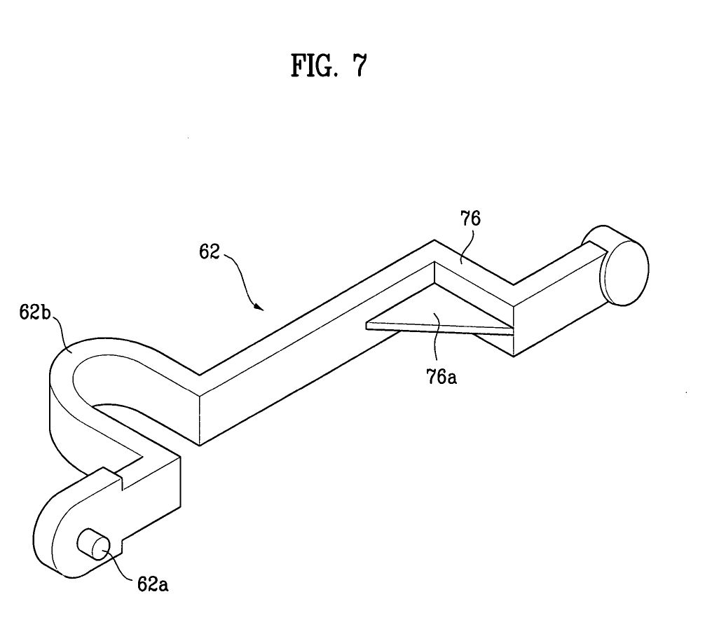

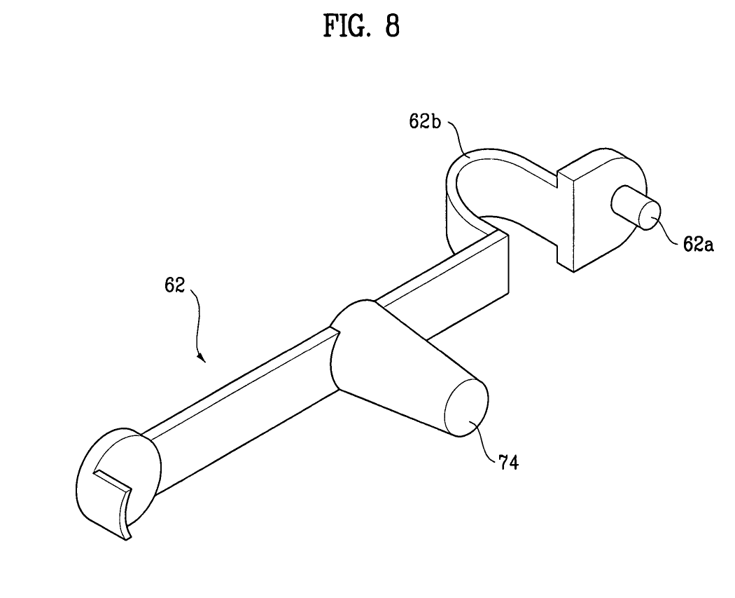

FIG. 5 and FIG. 6 are cross-sectional views of a control panel according to the present invention, and FIG. 7 and FIG. 8 are perspective views of a lever according to the present invention.

Referring to FIG. 5 and FIG. 8, a display part (not shown in the drawing) for displaying an operational status of the washing machine and at least one switch 58 for controlling an operation of the washing machine are formed on the display substrate 60.

In this case, a micro or snap switch is used as the switch 58 and LED or LCD is used as the display part. The display substrate 60 on which the switch 58 and the display part (not shown in the drawing) are integrated is formed smaller than the display panel 56.

Meanwhile, a switch lever 62 is provided between the display panel 56 and the display substrate 60 to operate the switch 58 by receiving an external force applied to the button 54.

The switch lever 62 includes one end fixed to a backside of the display panel and the other end disposed over the switch 58. And, the button 54 lies between both ends of the switch lever 62. The button 54 moves downward by an external force to come into contact with the switch lever 62.

In this case, a lever loading part 70 is formed at the backside of the display panel 56 to be coupled with the switch lever 62. Moreover, a coupling recess 70a is formed at the lever loading part 70, whereas a protrusion 62a inserted in the coupling recess 70a is formed at the switch lever 62. Hence, as the protrusion 62a is fitted to the coupling recess 70a, the switch lever 62 is fixed to the backside of the display panel 56.

Of course, the switch lever 62 can be directly fixed to the backside of the display panel 56 through a screw or the like.

Meanwhile, an elastic part 62b is provided at the switch lever 62 to return the switch lever 62 to its original state once the external force applied to the button 54 is released. The elastic part 62b is circularly curved to elastically expand and contract.

Namely, once the external force is transferred to the switch lever 62 through the button 54, the elastic part 62b gets wider right and left to expand. Once the external force is released, the elastic part 62b contracts again.

In order to facilitate to transfer the external force, which is applied to the button 54, to the switch lever 62, a button protrusion 78 is formed at a bottom of the button 54. The button protrusion 78 is brought contact with the switch lever 62 when the button 54 is pressed by the external force.

Besides, in case that it is difficult to form the button protrusion 86 due to a shape or structure of the button 54, another protrusion 74 may be formed on the switch lever 62 to be directly contacted with the button 54.

Meanwhile, a bent part 76 may be formed at the switch lever 62. The bent part 76 is provided at one side of the switch lever 62 to give a height difference between both ends of the switch lever 62 when the switch lever 62 is disposed at a position lower than that of the switch 58.

And, a rib 76a is preferably provided at the bent part 76 for reinforcing rigidity thereof.

An operation of the above-constructed control panel according to the present invention is explained as follows.

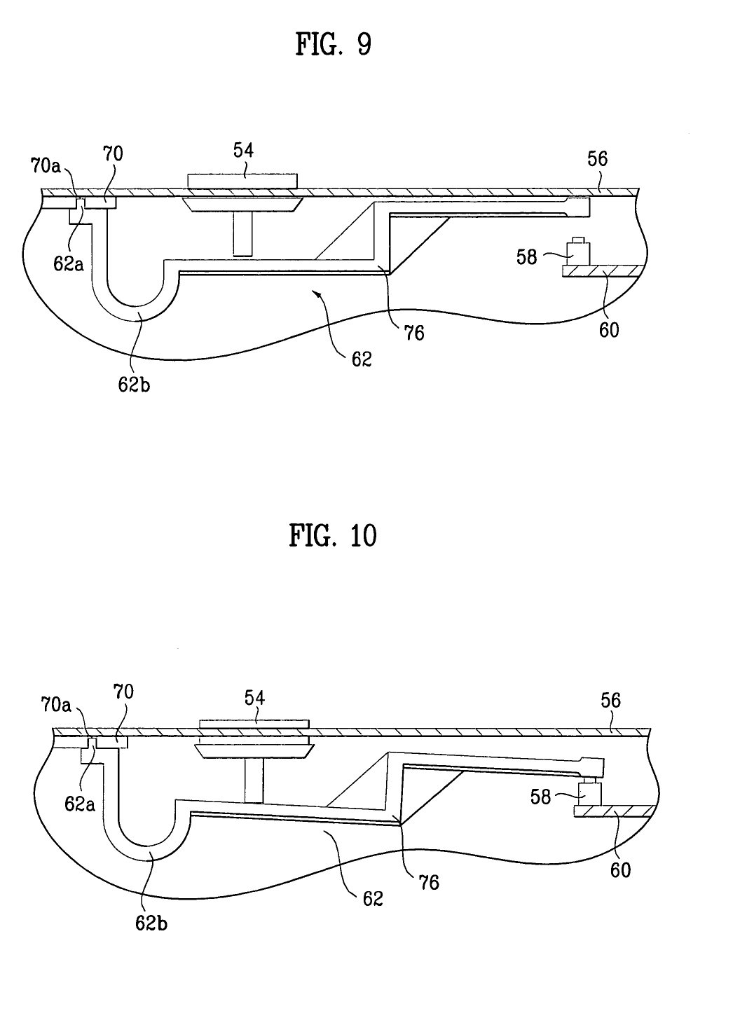

FIG. 9 and FIG. 10 are cross-sectional views for explaining an operation of a control panel according to the present invention.

Referring to FIG. 9 and FIG. 10, once a user presses the button 54, the button 54 comes into contact with the switch lever 62 to push a middle portion of the switch lever 62 downward.

In this case, since one end of the switch lever 62 is fixed to the display panel 56, the switch lever 62 becomes bent centering around the fixed portion and the elastic part 62b gets wider tight and left to expand.

And, the other end of the switch lever 62 moves toward the display substrate 60 to press the switch 58.

Thereafter, when the button 54 is released, the elastic part 62b returns to its original status by elasticity and the other end of the switch lever 62 is separated from the switch 58.

Therefore, whenever the user presses or releases the button 54, the switch 58 repeats to be turned on/off so as to drive/stop the operation controlled by the switch 58.

The above-described operation of the control panel 50 may be changed according to the locations and structures of the button 54 and the switch 58 as well as the shape and structure of the switch lever 62.

The control panel of the washing machine according to the present invention has the following advantages or effects.

First of all, the control panel according to the present invention utilizes the lever means for turning on/off the switch according to pressing/releasing the button, thereby facilitates to arrange the button for the switch.

Secondly, the control panel according to the present invention optimizes the switch on the display substrate regardless of the arrangement of the corresponding button, thereby enabling to downsize the display substrate. Therefore, the product cost of the display substrate is reduced as well.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A control panel of a washing machine, comprising:
a frame provided on a cabinet to form an exterior;
a display panel on a front side of the frame to have at least one button formed thereon;
a display substrate in rear of the display panel to have at least one switch formed thereon; and
a switch lever having one end fixed to a backside of the display panel and the other end disposed over the switch, the switch lever operating the switch by receiving an external force applied to the button.

2. The control panel of the washing machine as claimed in claim 1, wherein a lever loading part is formed on the backside of the display panel and the switch lever is coupled with the lever loading part.

3. The control panel of the washing machine as claimed in claim 2, wherein a coupling recess is formed at the lever loading part and a protrusion to be inserted in the coupling recess is formed at the switch lever.

4. The control panel of the washing machine as claimed in claim 1, wherein an elastic part is provided at the switch lever to return the switch lever to an original state when the external force applied to the button is released.

5. The control panel of the washing machine as claimed in claim 4, wherein the elastic part circularly becomes curved to elastically expand or contract according to the external force.

6. The control panel of the washing machine as claimed in claim 1, wherein a button protrusion is formed at a bottom of the button to be brought contact with the switch lever once the external force is applied to the button.

7. The control panel of the washing machine as claimed in claim 1, wherein a protrusion is formed at a top of the switch lever to be brought contact with the first lever once the external force is applied to the button.

8. The control panel of the washing machine as claimed in claim 1, wherein a bent part is formed at one side of the switch lever.

9. The control panel of the washing machine as claimed in claim 8, wherein a rib is provided at the bent part for rigidity reinforcement.
